(19) United States
(12) Patent Application Publication
(10) Pub. No.: US 2016/0373186 A1
(43) Pub. Date: Dec. 22, 2016

(54) COMPENSATING FOR OPTICAL SIGNAL DEGRADATION

(71) Applicant: Lenovo Enterprise Solutions (Singapore) Pte. Ltd., Singapore (SG)

(72) Inventors: Shareef F. Alshinnawi, Apex, NC (US); Gary D. Cudak, Wake Forest, NC (US); Edward S. Suffern, Durham, NC (US); J. Mark Weber, Wake Forest, NC (US)

(21) Appl. No.: 14/740,759

(22) Filed: Jun. 16, 2015

(51) Int. Cl. H04B 10/079; H04B 10/564; H04B 10/50; H04L 1/20

(52) U.S. Cl. CPC H04B 10/07953; H04L 1/203; H04B 10/564; H04B 10/503

(57) ABSTRACT

A method includes a first optical transmitter generating a first data signal at a first end of a fiber optic cable, wherein the first optical transmitter and a first photodetector are included in a first optical transceiver. The method further includes a second photodetector receiving a second data signal at a second end of the fiber optic cable. The second photodetector and the a second optical transmitter are included in a second optical transceiver, and the second data signal is the result of the first data signal passing from the first optical transmitter through the fiber optic cable to the second photodetector. A bit error rate in the second data signal is determined and, in response to the bit error rate exceeding a setpoint, the second optical transmitter sends a message to the first photodetector. The power output of the first optical transmitter is increased responsive to the message.

### BACKGROUND

Field of the Invention

The present invention relates to communication using optical signals over a fiber optic cable.

Background of the Related Art

Active optical cables may be used to facilitate communication between many network devices. Each active optical cable may use a laser as a source of an optical signal. However, over time a number of these active optical cables experience failure. One cause of active optical cable failure is oxidation of an aperture through which light is emitted from the laser.

During manufacturing of the laser, such as a vertical-cavity surface-emitting laser (VCSEL), the laser can become contaminated. This contamination goes undetected during the wafer test and cannot be detected by early life failure analysis. Even stress testing of the laser will not force the laser to failure. Unfortunately, over time this undetected contamination can cause an increasing amount of oxidation on the surface of the aperture from the laser. This oxidation blocks light from the laser and reduces the laser's effective power output. Eventually, the cumulative oxidation of the aperture reduces the power output of the laser to such an extent that there is a significant reduction in the power of the optical signal detected by a photodetector at the other end of the optical cable causing data errors at the receiver.

### BRIEF SUMMARY

One embodiment of the present invention provides a method comprising a first optical transmitter generating a first data signal at a first end of a fiber optic cable, wherein the first optical transmitter and a first photodetector are included in a first optical transceiver. The method further comprises a second photodetector receiving a second data signal at a second end of the fiber optic cable, wherein the second photodetector and the a second optical transmitter are included in a second optical transceiver, and wherein the second data signal is the result of the first data signal passing from the first optical transmitter through the fiber optic cable to the second photodetector. According to the method, a bit error rate in the second data signal is determined and, in response to the bit error rate exceeding a predetermined setpoint, the second optical transmitter sends a message to the first photodetector. The power output of the first optical transmitter is then increased in response to receiving the message.

Another embodiment of the present invention provides a computer program product comprising a non-transitory computer readable storage medium having program instructions embodied therewith, the program instructions executable by a processor to cause the processor to perform a method. The method comprises determining a bit error rate in a second data signal received by a photodetector at a second end of a fiber optic cable from a first optical transmitter that is transmitting the data signal from a first end of the fiber optic cable, wherein the second data signal is the result of the first data signal passing through an aperture of the first optical transmitter and through the fiber optic cable to the photodetector. In response to the bit error rate exceeding a predetermined setpoint, the method causes a second optical transmitter at the second end of the fiber optic cable to transmit a message over the fiber optic cable to a photodetector at the first end of the fiber optic cable. The method further comprises increasing the power output of the first optical transmitter in response to receiving the message.

### BRIEF DESCRIPTION OF THE SEVERAL VIEWS OF THE DRAWINGS

FIG. 1 is a diagram of the surface of an aperture in a laser.

FIG. 2 is a diagram of an active fiber optic cable having an optical transceiver at each end.

FIG. 3 is a graph of a bit error rate of data received at a photodetector over the lifetime of an optical transmitter.

FIG. 4 is a flowchart of a method of increasing the output power of a laser in response to oxidation of the aperture in a laser.

### DETAILED DESCRIPTION

One embodiment of the present invention provides a method comprising a first optical transmitter generating a first data signal at a first end of a fiber optic cable, wherein the first optical transmitter and a first photodetector are included in a first optical transceiver. The method further comprises a second photodetector receiving a second data signal at a second end of the fiber optic cable, wherein the second photodetector and the a second optical transmitter are included in a second optical transceiver, and wherein the second data signal is the result of the first data signal passing from the first optical transmitter through the fiber optic cable to the second photodetector. According to the method, a bit error rate in the second data signal is determined and, in response to the bit error rate exceeding a predetermined setpoint, the second optical transmitter sends a message to the first photodetector. The power output of the first optical transmitter is then increased in response to receiving the message.

The first and second optical transmitters may be light-emitting diodes, lasers, or a combination thereof. A preferred optical transmitter is a laser, such as a vertical-cavity surface-emitting lasers. Each optical transmitter generates a data signal in the form of light that is transmitted along the length of a fiber optic cable. The data signal is a digital signal comprising a series of bits. The content of the data signal is dependent upon the data input to the optical transmitter, which may originate from a network device driver.

The first photodetector may be coupled to a first error detection and correction circuit and the first optical transmitter may be coupled to a first data buffer. Both the first error detection and correction circuit and the first data buffer may also be coupled to an integrated with a first microprocessor that controls data input received by the first photodetector and data to be outputted by the first optical transmitter. Similarly, the second photodetector is coupled to a second error detection and correction circuit and the second optical transmitter is coupled to a second data buffer. Both the second error detection and correction circuit and the second data buffer may also be coupled to an integrated with a second microprocessor that controls data input received by the second photodetector and data to be output by the second optical transmitter. In addition to handling data input and output for the respective optical transceivers, each microprocessor may be responsible for determining a bit error rate (BER) (i.e., number of bits received in error÷total number of bits received) based on the information received from the error detection and correction circuitry. Therefore, the second microprocessor is able to monitor the bit error rate (BER) in the second data signal over time. While errors may be the result of various causes, the present method addresses an increase in the bit error rate resulting from oxidation of an aperture of the optical transmitter. Since the oxidation forms an opaque layer on the surface of the aperture from the optical transmitter, the effective power output of the optical transmitter is reduced. Therefore, the power of the first data signal generated by the first optical transmitter at the first end of the fiber optic cable is reduced. At the opposing second end of the fiber optic cable, the second photodetector detects a second data signal that has similarly reduced power and is more subject to error. The methods of the present invention use a gradually increasing bit error rate at the second photodetector as an indication of the extent of such oxidation at the first optical transmitter. Accordingly, the second microprocessor may send a message through the second data buffer, the second optical transmitter, and the fiber optic cable to the first microprocessor via the first photodetector requesting an increase in the output power of the first optical transmitter that will compensate for the aperture closure prior to the cable degradation having any significant adverse effect on network operation. The first microprocessor may then cause an increase in the output power of the first optical transmitter. For example, the power output of the first optical transmitter may be increased by a preset amount in response to receiving the message.

In another option, the microprocessors may generate a certain sequence of K-codes for synchronization of the transmission and reception of the data signals in each direction. However, certain K-codes are not used for synchronization of the transmission and reception of data, and those unused K-codes may be used to transmit information (i.e., data and messages) between the receive end and the transmit end of the cable connection. In one option, the message may be sent from the second microprocessor using the second data buffer and the second optical transmitter to the first microprocessor via the first photodetector during a time period when the first optical transmitter is not generating the first data signal to the second photodetector.

In a further embodiment, the first microprocessor may encode data that is received from a first host device before the data is input to the first transmitter for generating the first data signal. The first host device may be a computer including a network device driver that controls operation of a network adapter within the computer. In one option, the message may include codes that are not used in the encoding of the data. For example, the data may be encoded using 8 b/10 b encoding and the message may include unused K-character codes. 10-Bit K codes that are not used in data transmission include K28.0, K28.1, K28.2, K28.3, K28.4, K28.5, K28.6, K28.7, K23.7, K27.7, K29.7, and K30.7. In a further option, a message may include a start message portion, an increase portion and an end message portion. For example, a start message portion might include a first series of codes (i.e., K28.0, K28.1, K28.1, K28.0, K28.0, K28.1, K28.1, K28.0, K28.0, K28.1, K28.1, K28.0), an increase portion might incudes a second series of codes (i.e., K28.5, K28.5, K28.5, K28.5, K28.5) and an end message portion might include a third series of codes (i.e., K29.7, K30.7, K30.7, K29.7, K29.7, K30.7, K30.7, K29.7).

Various embodiments of the present invention may further comprise informing a host device coupled to the first optical transmitter that the first optical transmitter has degraded performance. In a first option, a host coupled to the first microprocessor may be informed that the first optical transmitter has degraded performance in response to the first photodetector receiving the message requesting an increase in the output power from the first optical transmitter. In a second option, a host coupled to the first microprocessor may be informed that the first optical transmitter has degraded performance in response to the first optical transmitter operating at maximum power. Accordingly, the method may incrementally increase the output power of the first optical transmitter to compensate for oxidation of the aperture of the first optical transmitter, but once the first optical transmitter is operating at maximum power the only remaining option is to replace the first optical transmitter. As a practical matter, replacing the first optical transmitter may involve replacing the entire fiber optic cable. In either option, the method may further comprise the host device adding the first optical transmitter or the fiber optic cable to a maintenance schedule for repair or replacement of the fiber optic cable.

It should be recognized that embodiments of the present invention are able to support communication in either or both directions between the first and second optical transceivers. Depending upon the network topology, an amount data communication over the fiber optic cable may be more-or-less equal in both directions or substantially only in one direction. In accordance with embodiments of the present invention, data transmitted in a first direction may result in a message sent back in the opposite second direction in order to increase the output power of the first optical transmitter transmitting the data. When data is not being transmitted in the first direction, data may be transmitted in the opposite direction. Accordingly, data transmitted in a second direction may result in a message sent back in the opposite first direction in order to increase the output power of the second optical transmitter transmitting the data. The output power of the first and second optical transmitters may be independently controlled in response to the amount of oxidation that may be occurring in the apertures of the individual optical transmitters.

Another embodiment of the present invention provides a computer program product comprising a non-transitory computer readable storage medium having program instructions embodied therewith, the program instructions executable by a processor to cause the processor to perform a method. The method comprises determining a bit error rate in a second data signal received by a photodetector at a second end of a fiber optic cable from a first optical transmitter that is transmitting the data signal from a first end of the fiber optic cable, wherein the second data signal is the result of the first data signal passing through an aperture of the first optical transmitter and through the fiber optic cable to the photodetector. In response to the bit error rate exceeding a predetermined setpoint, the method causes a second optical transmitter at the second end of the fiber optic cable to transmit a message over the fiber optic cable to a photodetector at the first end of the fiber optic cable. The method further comprises increasing the power output of the first optical transmitter in response to receiving the message.

The foregoing computer program products may further include computer readable program code for implementing or initiating any one or more aspects of the methods described herein. Accordingly, a separate description of the methods will not be duplicated in the context of a computer program product.

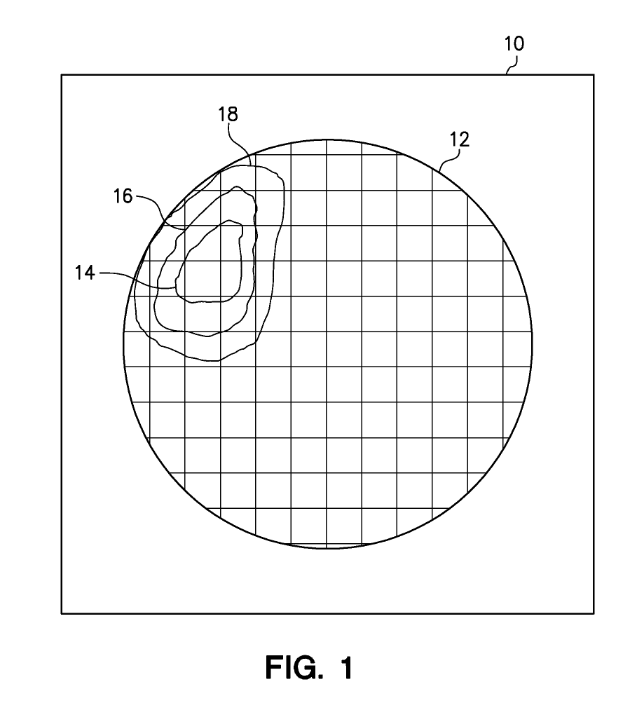

FIG. 1 is a diagram of the surface of a round aperture 12 in a vertical-cavity surface-emitting laser (VCSEL) 10. When the laser 10 is newly manufactured, the amount of oxidation is substantially undetectable. However, as discussed above, contamination may cause the surface of the aperture to undergo gradual oxidation. As illustrated in FIG. 1, the surface of the aperture 12 may develop oxidation covering a first area 14 over a first time period. The area 14 may represent about 2% of the surface area of the aperture 12, such that the effective output power of the laser is reduced by about 2%. Over time, the oxidation may increase to cover a second area 16 over a second time period and increase further to cover a third area 18 over a third time period. The second area 16 and the third area 18 may represent about 5% and 10% of the total surface area of the aperture 12, such that the output power of the laser 10 is significantly reduced and will continue to be reduced further with the passing of time. While the aperture 12 is illustrated with grid lines, this is only for emphasis of the extent of oxidation and it should be understood that an actual laser aperture may not have grid lines.

This “creeping oxidation” is slow and steady and closes up (i.e., degrades) the aperture of the laser over months of normal operation. As a result of this degradation, the bit error rate (BER) slowly gets worse. For example, the degradation may cause a change from an acceptable BER of 10⁻¹⁵ to a BER of 10⁻¹². Once the BER passes above a setpoint level (such as a BER of 10⁻¹²), the cable becomes virtually useless because of the large increase in the number of retries necessary to get good data at the second (receiving) optical transceiver.

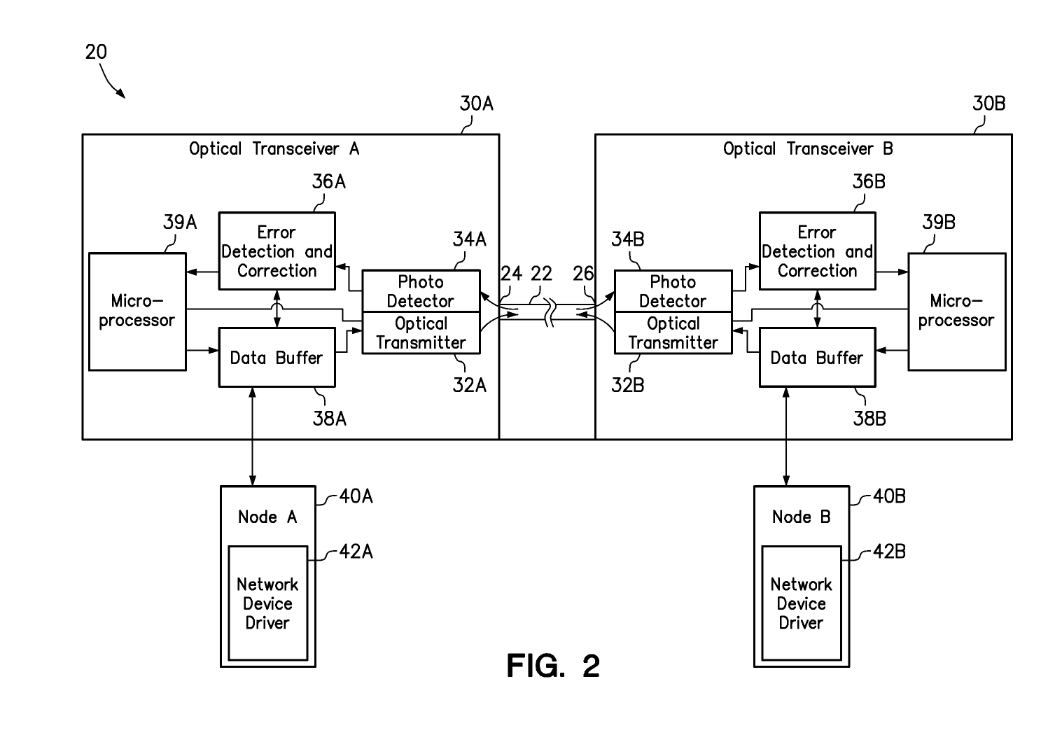

FIG. 2 is a diagram of an active fiber optic cable 20 having an optical transceiver at each end. The optical fiber 22 has a first end 24 and second end 26, wherein the first end has a first optical transceiver 30A including a first optical transmitter 32A for generating a first data signal and a first photodetector 34A for receiving a second data signal. The first photodetector 34A converts an optical signal into an electrical signal that is provided to a first error detection and correction circuit 36A. A first data buffer 38A is also provided to temporarily store data that is being provided to the first optical transmitter 32A. Both the first error detection and correction circuit 36A and the first data buffer 38A are in communication with a first microprocessor 39A, such that the first microprocessor receives error detection information from the first error detection and correction circuit 36A and provides messages to the first data buffer 38A that should be sent to the second optical transceiver 30B. According to embodiments of the present invention, the first microprocessor 39A determines a bit error rate (BER) in the data signal received by the first photodetector, compares the BER to a setpoint value, and generates a message to the second optical transceiver 30B in response to determining that the BER has exceeded the setpoint value.

The second end 26 of the optical fiber 22 is coupled to the second optical transceiver 30B, which includes a second optical transmitter 32B for generating a message and a second photodetector 34B for receiving the message. At any point in time, the roles of the first and second transceivers as “transmitting” and “receiving” may be reversed, and both transceivers 30A, 30B are capable of generating and receiving data signals and messages. The second photodetector 34B converts an optical signal into an electrical signal that is provided to a second error detection and correction circuit 36B. A second data buffer 38B is also provided to temporarily store data that is being provided to the second optical transmitter 32B. Both the second error detection and correction circuit 36B and the second data buffer 38B are in communication with a second microprocessor 39B, such that the second microprocessor receives error detection information from the second error detection and correction circuit 36B and provides messages to the second data buffer 38B that should be sent to the first optical transceiver 30A. According to embodiments of the present invention, the second microprocessor 39B determines a bit error rate (BER) in the data signal received by the second photodetector, compares the BER to a setpoint value, and generates a message to the first optical transceiver 30A in response to determining that the BER has exceeded the setpoint value.

In one example, data is sent from a first node (Node A) 40A to a second node (Node B) 40B. Accordingly, the network device driver 42A sends data to a first data buffer 38A that provides input to the first optical transmitter 32A. The first optical transmitter 32A generates a first optical signal that is transmitted down the optical fiber 22 from the first end 24 to the second end 26. At the second end 26, a second photodetector 34B receives a second data signal and converts the light into an electrical signal. It should be recognized that the second data signal is the result of the first data signal after it has passed through the aperture of the first optical transmitter 32A and has traveled the length of the optical fiber 22. The second error detection and correction circuit 36B provides data error information to the second microprocessor 39B which determines a bit error rate (BER) in the second data signal. If the BER exceeds a setpoint value, then the second microprocessor 39B generates a message requesting a stronger data signal. The message may be provided to the second data buffer 38B such that, when the second photodetector 34B is not receiving a data signal (i.e., when the optical fiber is not busy carrying other signals), the second optical transmitter 32B may send the message to the first photodetector 34A. Optionally, the message may use unique codes that are not used in typical data signals.

The first photodetector 34A receives the message and converts it to an electrical signal. The first microprocessor 39A recognizes the unique codes as a request for a stronger data signal. Accordingly, the microprocessor 36A instructs the first optical transmitter 32A to increase its output power, perhaps by a preset amount. It should be appreciated that as oxidation of the aperture in the first optical transmitter 32A progresses, the optical transceiver 30B detects an increasing BER and requests an increase in the output power of the first optical transmitter. This method may be performed proactively to prevent the BER from negatively affecting network performance.

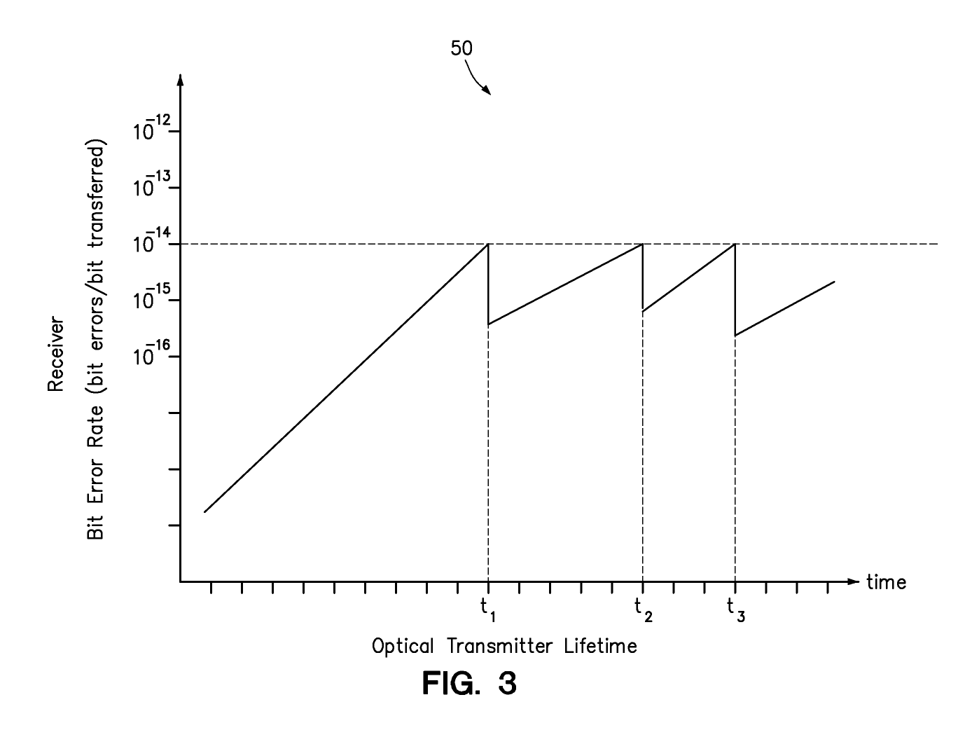

FIG. 3 is a hypothetical graph 50 of a bit error rate (BER) of data received at a photodetector over the lifetime of an optical transmitter. As shown, the BER is initially very low and rising gradually over time. In accordance with one embodiment of the present invention, a setpoint of 10⁻¹⁴ has been established such that a measured BER exceeding the setpoint will request in generating a message requesting an increase in the output power. As illustrated, such messages are generated at times t₁, t₂ and t₃. Each time that the output power is increased, the BER drops for a period of time until oxidation has further degraded the data signal. A message requesting an increase in the output power of an optical transmitter may be sent any number of times. However, the output power of an optical transmitter is limited and the fiber optic cable may eventually need to be replaced.

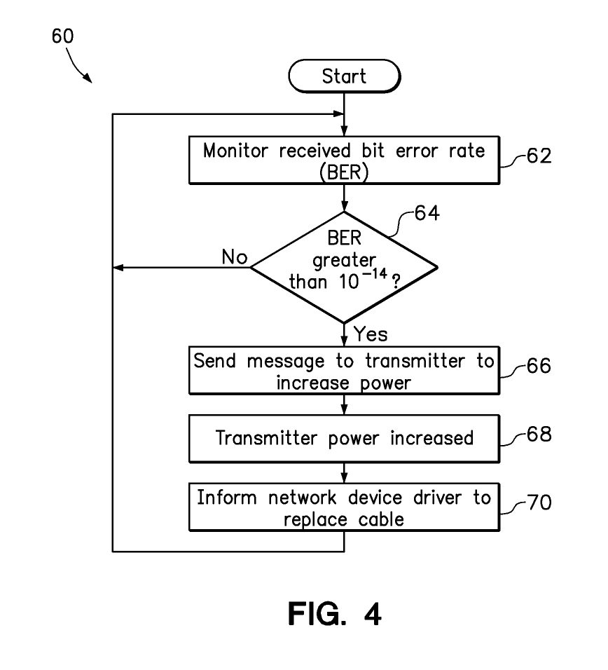

FIG. 4 is a flowchart of a method 60 of increasing the output power of a laser in response to oxidation of the aperture in the laser. In step 62, an optical transceiver receives a data signal and monitors a bit error rate (BER) in the received data signal. In step 64, the method determines whether the BER is greater than the setpoint amount (i.e., 10⁻¹⁴). If the BER is not greater than the setpoint amount, then the method returns to step 62 to monitor the BER in the received data signal. However, if the BER is greater than the setpoint amount (i.e., 10⁻¹³ >10⁻¹⁴), then the method proceeds to send a message to the optical transmitter to request an increase in output power in step 66. In step 68, the optical transmitter's output power is increased. The method may optionally inform the network device driver that the cable should be replaced in step 70.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a first optical transmitter generating a first data signal at a first end of a fiber optic cable, wherein the first optical transmitter and a first photodetector are included in a first optical transceiver;
a second photodetector receiving a second data signal at a second end of the fiber optic cable, wherein the second photodetector and the a second optical transmitter are included in a second optical transceiver, and wherein the second data signal is the result of the first data signal passing through an aperture of the first optical transmitter and through the fiber optic cable to the second photodetector;
determining a bit error rate in the second data signal;
in response to the bit error rate exceeding a predetermined setpoint, the second optical transmitter sending a message to the first photodetector; and
increasing the power output of the first optical transmitter in response to receiving the message.

2. The method of claim 1, wherein the message is sent from the second optical transmitter to the first photodetector during a time period when the first optical transmitter is not generating the first data signal to the second photodetector.

3. The method of claim 1, wherein the first optical transmitter includes a light emitting diode.

4. The method of claim 1, wherein the first optical transmitter includes a laser.

5. The method of claim 4, wherein the laser is a vertical-cavity surface-emitting laser.

6. The method of claim 1, further comprising:
monitoring the bit error rate in the second data signal over time.

7. The method of claim 1, further comprising:
in response to the first optical transmitter operating at maximum power, informing a host coupled to the first optical transmitter that the fiber optic cable has degraded performance.

8. The method of claim 1, further comprising:
in response to receiving the message, informing a host coupled to the first optical transmitter that the fiber optic cable has degraded performance.

9. The method of claim 1, further comprising:
a first host device encoding data that is input to the first transmitter for generating the first data signal.

10. The method of claim 9, wherein the message includes codes that are not used in the encoding of the data.

11. The method of claim 10, wherein the data is encoded using 8 b/10 b encoding and the message includes unused K-character codes.

12. The method of claim 1, wherein the power output of the first optical transmitter is increased by a preset amount in response to receiving the message.

13. The method of claim 1, wherein the first optical transceiver includes a first microprocessor in communication with the first photodetector and the first optical transmitter, and the second optical transceiver includes a second microprocessor in communication with the second photodetector and the second optical transmitter, wherein the second microprocessor determines the bit error rate in the second data signal and generates the message, and wherein the first microprocessor obtains the message from the first photodetector and instructs the first optical transmitter to increase the power output.

14. A computer program product comprising a non-transitory computer readable storage medium having program instructions embodied therewith, the program instructions executable by a processor to cause the processor to perform a method comprising:
determining a bit error rate in a second data signal received by a photodetector at a second end of a fiber optic cable from a first optical transmitter that is transmitting the data signal from a first end of the fiber optic cable, wherein the second data signal is the result of the first data signal passing through an aperture of the first optical transmitter and through the fiber optic cable to the photodetector;
in response to the bit error rate exceeding a predetermined setpoint, causing a second optical transmitter at the second end of the fiber optic cable to transmit a message over the fiber optic cable to a photodetector at the first end of the fiber optic cable; and
increasing the power output of the first optical transmitter in response to receiving the message.

15. The computer program product of claim 14, wherein the message is sent from the second optical transmitter to the first photodetector during a time period when the first optical transmitter is not generating the first data signal to the second photodetector.

16. The computer program product of claim 14, the method further comprising:
in response to the first optical transmitter operating at maximum power, informing a host coupled to the first optical transmitter that the fiber optic cable has degraded performance.

17. The computer program product of claim 14, the method further comprising:
in response to receiving the message, informing a host coupled to the first optical transmitter that the fiber optic cable has degraded performance.

18. The computer program product of claim 14, further comprising:
encoding data that is input to the first transmitter for generating the first data signal.

19. The computer program product of claim 18, wherein the message includes codes that are not used in the encoding of the data.

20. The computer program product of claim 14, wherein the power output of the first optical transmitter is increased by a preset amount in response to receiving the message.
